(19) United States
(12) Patent Application Publication
(10) Pub. No.: US 2024/0159608 A1
(43) Pub. Date: May 16, 2024

(54) SYSTEM AND METHOD FOR DETERMINING TORQUE IN A TURBOMACHINE

(71) Applicants: General Electric Company, Schenectady, NY (US); GE Avio S.r.l., Rivalta di Torino (IT)

(72) Inventors: Bugra Han Ertas, Niskayuna, NY (US); Leonardo Coviello, Bari (IT); Juraj Hrubec, Dolny Kubin (SK); Joseph Alfred Iannotti, Glenville, NY (US); Eric Richard Westervelt, Niskayuna, NY (US); Keith F. Beatty, Cincinnati, OH (US); Bradley Alan Bauer, Cincinnati, OH (US)

(21) Appl. No.: 17/988,170

(22) Filed: Nov. 16, 2022

(51) Int. Cl. G01L 5/12; F01D 15/12; F01D 19/00

(52) U.S. Cl. CPC G01L 5/12; F01D 15/12; F01D 19/00; F05D 2270/335

(57) ABSTRACT

A power transmission gearbox system for a turbomachine is provided. the power transmission gearbox system includes a drivetrain having one or more rotating components. The system further includes at least one static component interfacing with the one or more rotating components. The system further includes a sensor disposed on the at least one static component and configured to provide data indicative of strain in the static component. The system further includes a controller communicatively coupled to the sensor. the controller includes a processor and a memory. the processor is configured to perform a plurality of operations. The plurality of operations includes monitoring the data indicative of strain in the static component from the sensor. The operations further include determining, at least partially based on the data indicative of the strain in the static component, a torque in the one or more rotating components of the drivetrain.

### FIELD

The present disclosure relates to a system and method for determining torque in a power transmission gearbox system for a turbomachine.

### BACKGROUND

A gas turbine engine generally includes a fan and a core arranged in flow communication with one another with the core disposed downstream of the fan in the direction of the flow through the gas turbine. The core of the gas turbine engine generally includes, in serial flow order, a compressor section, a combustion section, a turbine section, and an exhaust section. With multi-shaft gas turbine engines, the compressor section can include a high pressure compressor (HP compressor) disposed downstream of a low pressure compressor (LP compressor), and the turbine section can similarly include a low pressure turbine (LP turbine) disposed downstream of a high pressure turbine (HP turbine). With such a configuration, the HP compressor is coupled with the HP turbine via a high pressure shaft (HP shaft), and the LP compressor is coupled with the LP turbine via a low pressure shaft (LP shaft).

In operation, at least a portion of air over the fan is provided to an inlet of the core. Such portion of the air is progressively compressed by the LP compressor and then by the HP compressor until the compressed air reaches the combustion section. Fuel is mixed with the compressed air and burned within the combustion section to provide combustion gases. The combustion gases are routed from the combustion section through the HP turbine and then through the LP turbine. The flow of combustion gasses through the turbine section drives the HP turbine and the LP turbine, each of which in turn drives a respective one of the HP compressor and the LP compressor via the HP shaft and the LP shaft. The combustion gases are then routed through the exhaust section, e.g., to atmosphere.

The LP turbine drives the LP shaft, which drives the LP compressor. In addition to driving the LP compressor, the LP shaft can drive the fan through a gearbox, which allows the fan to be rotated at fewer revolutions per unit of time than the rotational speed of the LP shaft for greater efficiency. The LP shaft provides the input to the gearbox, while the fan is coupled to an output shaft. The gearbox may include one or more gears coupled to an input shaft and an output shaft (which collectively define a drivetrain of the gearbox).

A system and method for determining the torque experienced by the components in the drivetrain would be appreciated in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a cross-sectional view of a gas turbine engine in accordance with an exemplary aspect of the present disclosure.

FIG. 2 illustrates a cross-sectional view of a power transmission gearbox system in accordance with an exemplary aspect of the present disclosure;

FIG. 3 illustrates a perspective view of one or more static components of a power transmission gearbox system in accordance with an exemplary aspect of the present disclosure;

FIG. 4 illustrates a cross-sectional view of the one or more static components shown in FIG. 3 in accordance with an exemplary aspect of the present disclosure;

FIG. 5 illustrates a power transmission gearbox system in accordance with embodiments of the present disclosure;

FIG. 6 illustrates a perspective view of a static component of the power transmission gearbox system in accordance with an exemplary aspect of the present disclosure;

FIG. 7 illustrates a planar view of a static component of the power transmission gearbox system in accordance with an exemplary aspect of the present disclosure;

FIG. 8 is a graph showing a strain measurement between a first sensor, a second sensor, and a third sensor that is indicative of engine torque in accordance with an exemplary aspect of the present disclosure;

FIG. 9 is a graph showing a strain measurement between a first sensor, a second sensor, and a third sensor that is indicative of engine bending in accordance with an exemplary aspect of the present disclosure;

FIG. 10 illustrates a control logic diagram in accordance with an exemplary aspect of the present disclosure;

FIG. 11 illustrates a graph of torque data plotted against real time in accordance with an exemplary aspect of the present disclosure;

FIG. 12 illustrates an FFT graph of a magnitude of torque data at various frequencies corresponding with one or more torsional operating modes of rotating components in a drivetrain in accordance with an exemplary aspect of the present disclosure; and

FIG. 13 illustrates a flow diagram of a method for measuring torque in a power transmission gearbox system for a turbomachine in accordance with exemplary embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

Terms of approximation, such as “generally,” when used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The present disclosure is generally related to measuring drivetrain torque by utilizing a non-rotating strain measuring device/sensor on a static component of a power transmission gearbox system. The implementation of this sensor will enable a controller to determine static torque and also dynamic torque through the gearbox drivetrain. Once the static torque and the dynamic torque are determined by the controller, such parameters may be used to determine a low pressure turbine torque and/or a fan torque. The static torque and the dynamic torque may also be used to assess gearbox health (e.g., provide an estimate of remaining hardware life), provide a backup torque measurement, and/or to provide an additional feedback parameter for engine thrust control.

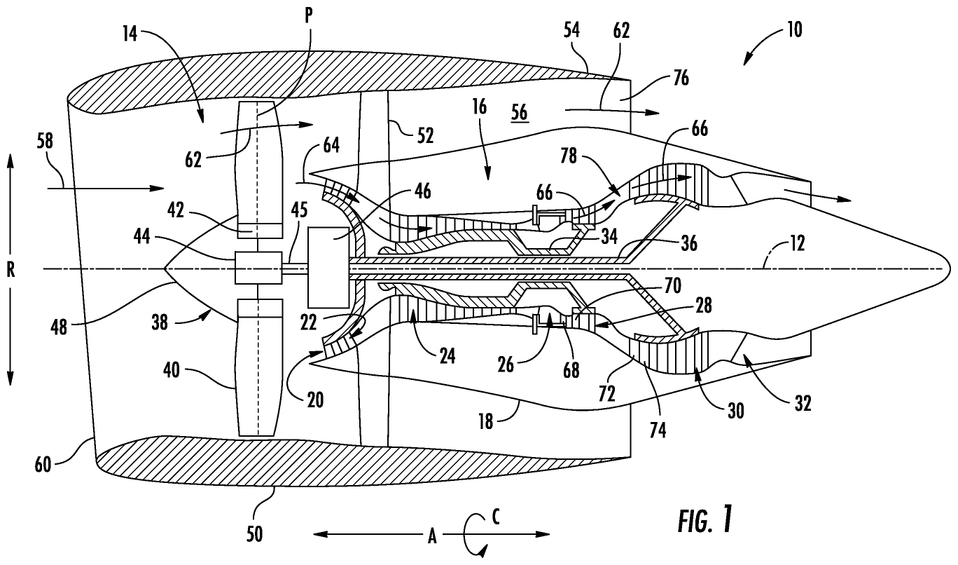

Referring now to the drawings, in which identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R that is normal to the axial direction A, and a circumferential direction C that extends around the longitudinal centerline 12. In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. As schematically shown in FIG. 1, the outer casing 18 encases, in serial flow relationship, a compressor section including a booster or low pressure (LP) compressor 22 followed downstream by a high pressure (HP) compressor 24; a combustion section 26; a turbine section including a high pressure (HP) turbine 28 followed downstream by a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22 to rotate them in unison. The compressor section, combustion section 26, turbine section, and nozzle section 32 together define a core air flowpath.

For the embodiment depicted in FIG. 1, the fan section 14 includes a variable pitch fan 38 having a plurality of fan blades 40 coupled to a disk 42 in a spaced apart manner. As depicted in FIG. 1, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40 in unison. The fan blades 40, disk 42, and actuation member 44 are together rotatable about the longitudinal axis 12 via a fan shaft 45 that is powered by the LP shaft 36 across a gearbox 46. The gearbox 46 includes a plurality of gears for adjusting the rotational speed of the fan shaft 45 and thus the fan 38 relative to the LP shaft 36 to a more efficient rotational fan speed.

Referring still to the exemplary embodiment of FIG. 1, the disk 42 is covered by a rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that the nacelle 50 may be configured to be supported relative to the core turbine engine 16 by a plurality of circumferentially-spaced outlet guide vanes 52. Alternatively, the nacelle 50 also may be supported by struts of a structural fan frame. Moreover, a downstream section 54 of the nacelle 50 may extend over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrow 62 is directed or routed into the bypass airflow passage 56, and a second portion of the air 58 as indicated by arrow 64 is directed or routed into the upstream section of the core air flowpath, or more specifically into the inlet 20 of the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed into and expand through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed into and expand through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and rotation of the fan 38 via the gearbox 46.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated, however, that the exemplary turbofan engine 10 depicted in FIG. 1 is by way of example only, and that in other exemplary embodiments, the turbofan engine 10 may have any other suitable configuration. For example, in other exemplary embodiments, the fan 38 may be configured in any other suitable manner (e.g., as a fixed pitch fan) and further may be supported using any other suitable fan frame configuration. Moreover, it also should be appreciated that in other exemplary embodiments, any other suitable LP compressor 22 configuration may be utilized. It also should be appreciated, that in still other exemplary embodiments, aspects of the present disclosure may be incorporated into any other suitable gas turbine engine. For example, in other exemplary embodiments, aspects of the present disclosure may be incorporated into, e.g., a turboshaft engine, turboprop engine, turbocore engine, turbojet engine, etc.

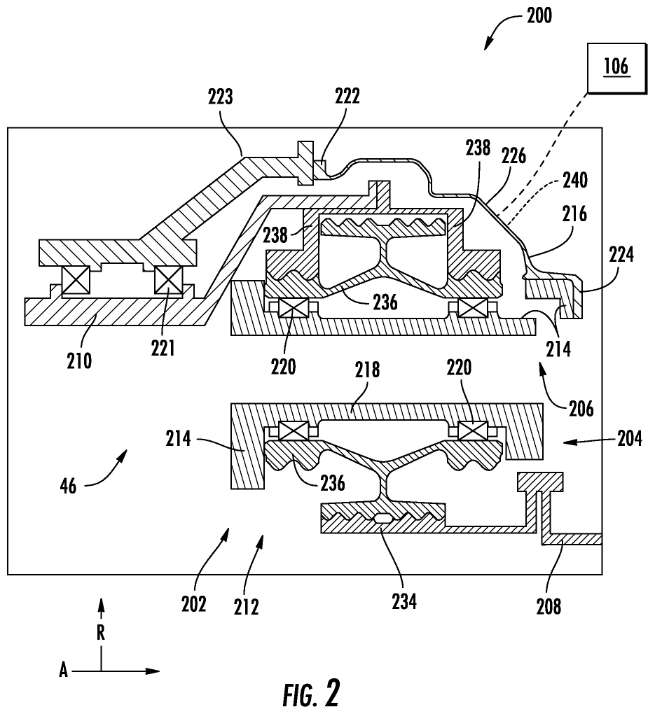

Referring now to FIG. 2, a cross-sectional view of a power transmission gearbox system 200 is illustrated in accordance with embodiments of the present disclosure. As shown in FIG. 2, the power transmission gearbox system 200 may include a gearbox 46 (such as the gearbox 46 discussed above with reference to FIG. 1 or a different gearbox). The gearbox 46 may include a drivetrain 202 that includes one or more rotating components 204, and the gearbox 46 may include one or more static components 206 that may surround the rotating components 204. The static components 206 may interface with the rotating components 204, e.g., via one or more rollers 220 and/or one or more bearings 221. As used herein, the term “static component” may include any non-rotating component or stationary component with respect to the rotating components 204 of the gearbox 46. For example, the static components 206 of the gearbox 46 do not move relative to the rotating components 204 of the gearbox 46. By contrast, the term “rotating component” may include any component of the gearbox 46 that rotates relative to the static components 206 of the gearbox 46.

The one or more rotating components 204 may include an input shaft 208, an output shaft 210, and one or more gears 212 coupled to the input shaft 208 and the output shaft 210. Particularly, the one or more gears 212 may include a sun gear 234, one or more planet gears 236, and a ring gear 238. Each planet gear 236 may be disposed between, and rotatably coupled to, the ring gear 238 and the sun gear 234. In some embodiments, as shown, the input shaft 208 may be coupled to the sun gear 234, and the output shaft 210 may be coupled to the ring gear 238. Particularly, the input shaft 208 may be coupled to the sun gear 214 at a first end and coupled to the LP shaft 36 at a second end (FIG. 1). The output shaft 210 may be coupled to the ring gear 238 at a first end and coupled to the fan shaft 45 at a second end (FIG. 1). While FIG. 2 illustrates one embodiment of a gearbox 46 having a particular gear arrangement, it should be appreciated that alternative gear arrangements may be utilized without departing form the scope or spirit of the present disclosure, and the present disclosure should not be limited to any particular gear arrangement unless specifically recited in the claims.

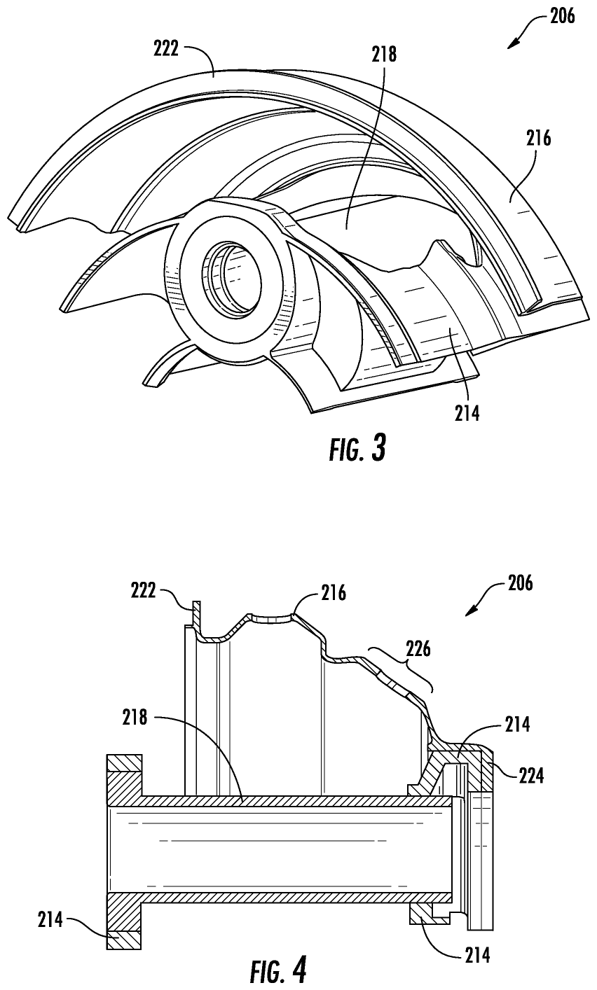

The one or more static components 206 may include a carrier 214, a carrier support 216 (or flex mount), and a pin 218. FIGS. 3 and 4 illustrate separate views of one or more static components 206 of the gearbox 46 isolated from the rotating components 204 of the gearbox 46. For example, FIG. 3 illustrates a perspective view of a carrier 214, a carrier support 216, and a pin 218 of the gearbox 46, and FIG. 4 illustrates a cross-sectional view of the carrier 214, the carrier support 216, and the pin 218 shown in FIG. 3.

Referring now to FIGS. 2 through 4 collectively, in many embodiments, the one or more gears 212 may surround the pin 218, and the pin 218 may extend through the carrier 214 and/or the one or more gears 212. For example, the pin 218 may extend generally axially from a first end attached to the carrier 214, through a planet gear 236, to a second end attached to the carrier 214. The pin 218 may interface or engage with the planet gear 236 via one or more rollers 220 (e.g., cylindrical rollers). The one or more planet gears 236 and the pin 218 may be disposed at least partially within, and coupled to, the carrier 214. The carrier support 216 may generally surround (e.g., circumferentially surround) the carrier 214 and the one or more gears 212. Additionally, the carrier support 216 may extend from the carrier 214. In many embodiments, the carrier support 216 may extend from an engine frame 223 to the carrier 214. For example, the carrier support 216 may extend from a first flange 222 coupled to the engine frame 223 to a second flange 224 coupled to the carrier 214 (e.g., via one or more bolted joints). In many embodiments, the carrier support 216 may be a generally flexible or compliant member that couples the carrier 214 to the engine frame 223 (e.g., a stationary support and/or the engine frame). In this way, the carrier support 216 (or flex mount) may experience reactionary torque from the forces of the one or more gears 212 in the gearbox 46 that cause strain in the carrier support 216.

In exemplary embodiments, the carrier support 216 may converge radially inward as the carrier support 216 extends axially from the first flange 222 to the second flange 224. In such embodiments, the carrier support 216 may include one or more conical sections or portions 226 that are angled, slanted, or otherwise oblique relative to both the axial direction A and the radial direction R.

In exemplary embodiments, the power transmission gearbox system 200 may include a sensor 240 disposed on the at least one static component 206. The sensor may be in communication with a controller 106 and configured to provide data indicative of a strain in the at least one static component 206 to the controller 106. In various embodiments, the sensor 240 may be disposed on the carrier 214, the carrier support 216, and/or the pin 218. For example, in exemplary embodiments, the sensor 240 may be disposed on the carrier support 216 and configured to sense data indicative of a strain in the carrier support 216. In particular embodiments, the sensor 240 may be disposed on the conical section 226 of the carrier support 216, which may be advantageous because of the general uniformity in the strain field experienced by the carrier support 216 in the conical section 226.

In various embodiments, the sensor 240 may be one of a strain gauge, a surface acoustic wave (SAW) sensor, a foil gauge, or any other suitable sensor configured to sense data indicative of a strain. The sensor 240 may be applied directly to the component in which the strain is to be measured (e.g., in contact with such component). For example, the sensor 240 may be applied directly to an outer surface of the carrier support 216, such that the sensor 240 is in contact with the outer surface of the carrier support 216, to measure data indicative of a strain in the carrier support 216.

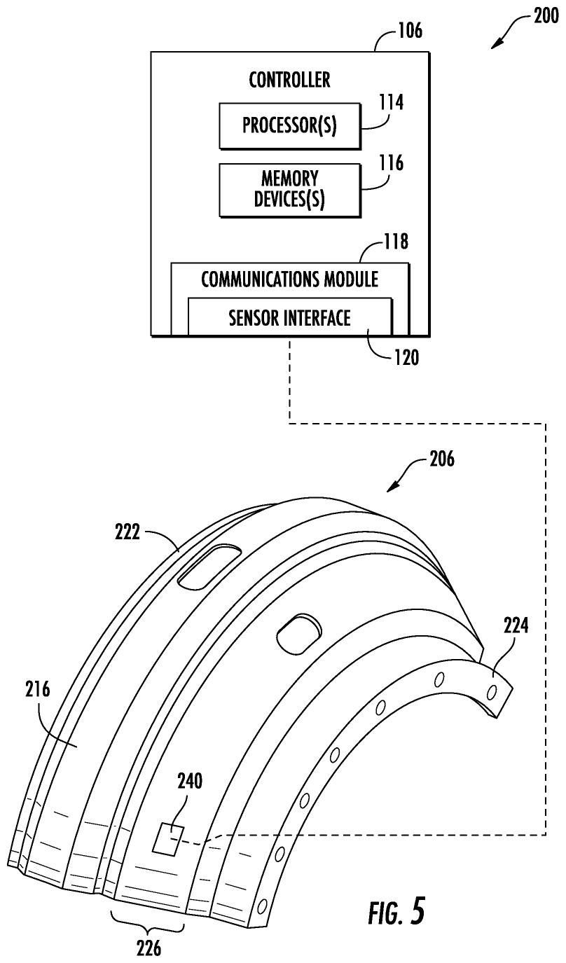

FIG. 5 illustrates a perspective view of the power transmission gearbox system 200 in accordance with embodiments of the present disclosure. As shown in FIG. 5, the power transmission gearbox system 200 may include a static component 206, which may be the carrier support 216. A sensor 240 may be disposed on the carrier support 216, e.g., on the conical section 226 of the carrier support 216. The sensor 240 may be in communication with a controller 106, such that the sensor 240 provides the controller 106 with data indicative of a strain in the carrier support 216.

Still referring to FIG. 5, the controller 106 is shown as a block diagram to illustrate the suitable components that may be included within the controller 106. As shown, the controller 106 may include one or more processor(s) 114 and associated memory device(s) 116 configured to perform a variety of computer-implemented functions (e.g., performing the methods, steps, calculations and the like and storing relevant data as disclosed herein). Additionally, the controller 106 may also include a communications module 118 to facilitate communications between the controller 106 and the various components of the system. For example, the communications module may include a sensor interface 120 (e.g., one or more analog-to-digital converters) to permit signals transmitted from the sensor 240 to be converted into signals that can be understood and processed by the processors 114. It should be appreciated that the sensor 240 may be communicatively coupled to the communications module 118 using any suitable means. For example, as shown in FIG. 5, the sensor 240 may be coupled to the sensor interface 120 via a wired connection. However, in other embodiments, the sensor 240 may be coupled to the sensor interface 120 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 116 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 116 may generally be configured to store suitable computer-readable instructions that, when implemented by the processor(s) 114, configure the controller 106 to perform various functions, operations, and/or calculations including monitoring the data indicative of strain in the static component 206 from the sensor 240 and determining, at least partially based on the data indicative of the strain in the static component, a torque in the one or more rotating components 204 of the drivetrain 202.

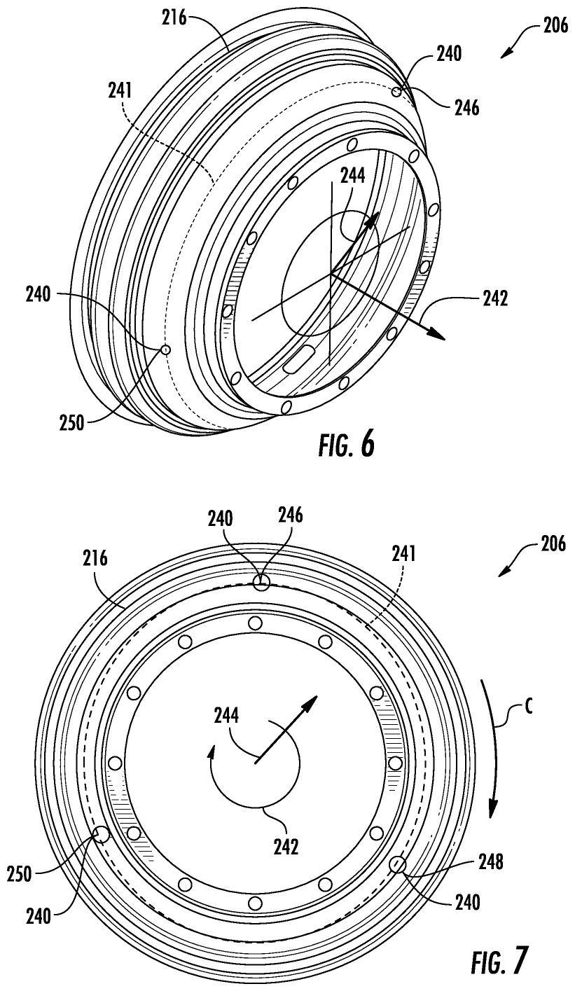

FIG. 6 illustrates a perspective view of a static component 206 of the power transmission gearbox system 200, and FIG. 7 illustrates a planar view of the static component 206 of the power transmission gearbox system 200, each in accordance with an exemplary aspect of the present disclosure. Particularly, FIGS. 6 and 7 each illustrate the carrier support 216. As shown in FIGS. 6 and 7, the sensor 240 may be a plurality of sensors 240 each in communication with the controller 106 and circumferentially spaced apart from one another on the static component 206. For example, the plurality of sensors 240 may include a first sensor 246, a second sensor 248, and a third sensor 250 spaced apart from one another. However, it should be appreciated that the system may include any number of sensors 240, and the present disclosure should not be limited to any particular number of sensors unless specifically recited in the claims.

In exemplary embodiments, each sensor 246, 248, and 250 of the plurality of sensors 240 may be equally spaced apart from one another (with respect to the circumferential direction C), which may advantageously reduce sensor noise. Additionally, as shown in FIGS. 6 and 7, each of the sensors 246, 248, and 250 may be disposed at the same axial location, such that each of the sensors 246, 248, and 250 lies in a common axial-radial plane. For example, each of the sensors 246, 248, and 250 may be positioned along a circumferential projection line 241 that extends along an outer surface of the carrier support 216. This may advantageously reduce sensor noise, provide a clear signal to the controller 106, and facilitate the comparison of the sensor data from each sensor 246, 248, and 250 in the plurality of sensors 240.

Additionally, as shown in FIGS. 6 and 7, the carrier support 216 may experience both engine torque 242 and engine bending 244. Engine torque 242 may be a moment force about the axial centerline of the carrier support 216 (and/or the gas turbine engine 10), and engine bending 244 may be a moment force about a radial projection from the axial centerline of the carrier support 216 (and/or the gas turbine engine 10).

In exemplary implementations of the power transmission gearbox system 200, the data indicative of the strain from each sensor 240 of the plurality of sensors 240 may be compared (e.g., by the controller 106) to determine what type of engine forces the carrier support 216 is being subjected to, and the controller may implement one or more control actions in response (i.e., adjust one or more operating conditions of the turbomachine).

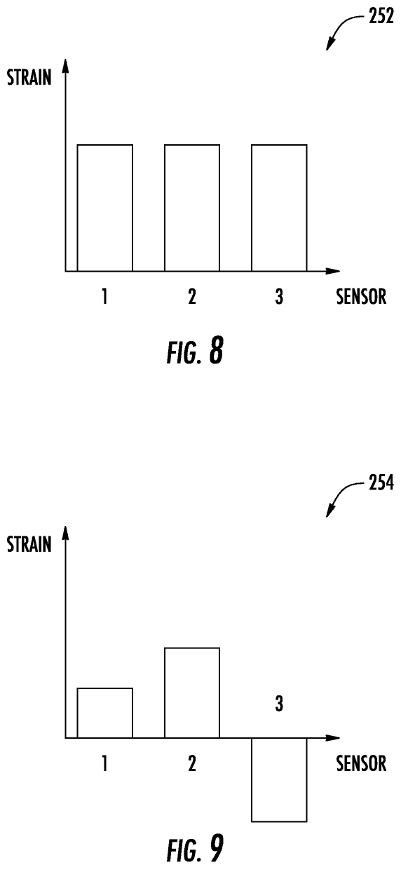

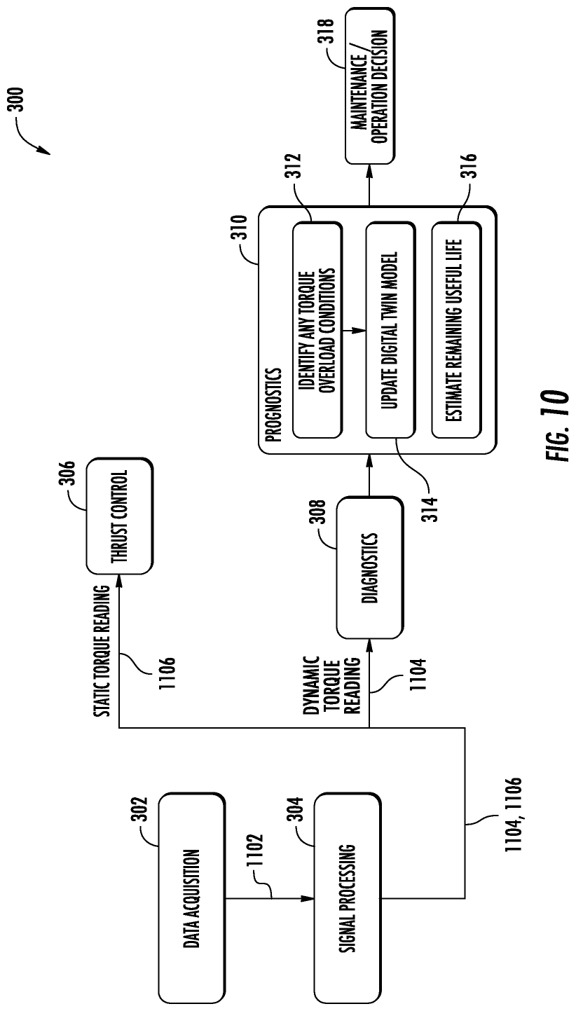

FIG. 8 illustrates a first graph 252 showing a strain measurement between the first sensor 246, the second sensor 248, and the third sensor 250 that is indicative of engine torque 242. For example, each of the strain measurements is substantially equal in the first graph 252 (e.g., within 10%, or within 5%, or within 2%), thereby indicating to the controller 106 that the carrier support 216 is experiencing engine torque 242. By contrast, FIG. 9 illustrates a second graph 254 showing a strain measurement between the first sensor 246, the second sensor 248, and the third sensor 250 that is indicative of engine bending 244. For example, each of the strain measurements in the second graph 254 have a high variance. Particularly, the controller 106 may be configured to detect when the variance of the strain measurements exceeds a predetermined threshold, thereby indicating that the carrier support 216 is experience engine bending 244. For example, when one or more of the strain measurements is more than 5% different (or more than 10%, or more than 15%, or more than 20%) than a mean or average of all the strain measurements, then the controller may determine that the carrier support 216 is experiencing engine bending 244.

FIG. 10 illustrates a control logic diagram 300, which may be implemented by the controller 106. For example, the various steps, functions, and/or calculations in the control logic diagram 300 may be stored in the memory 116 and/or executed by the processor 114 of the controller 106. Particularly, the control logic diagram 300 may be implemented by the controller 106 to collect and process data from the power transmission gearbox system 200, e.g., collect and process data from the sensor 240 coupled to the carrier support 216 of the power transmission gearbox system 200 described above.

Initially, the control logic diagram 300 may include a data acquisition step 302. The data acquisition step 302 may include receiving data indicative of a strain in one or more static components 206 of the power transmission gearbox system 200. In many implementations, the data acquisition step 302 may further include determining, at least partially based on the data indicative of a strain in the one or more static components 206, data indicative of a torque in one or more rotating components 204 in the drivetrain 202 of the power transmission gearbox system 200. For example, the sensor 240 and/or the controller 106 may be calibrated such that a measured strain in the static component 206 correlates with a torque in one or more rotating components 204 in the drivetrain 202.

The control logic diagram 300 may further include a signal processing step 304 once the data indicative of a torque in a rotating component 204 of the drivetrain 202 is received by the controller 106. For example, the signal processing step 304 may include extracting a static torque from a given time period of torque data. Additionally, the signal processing step 304 may include identifying one or more dynamic torque magnitudes by performing a Fast Fourier Transform (FFT) on the torque data, i.e., converting the torque signal from its original domain to a representation in the frequency domain.

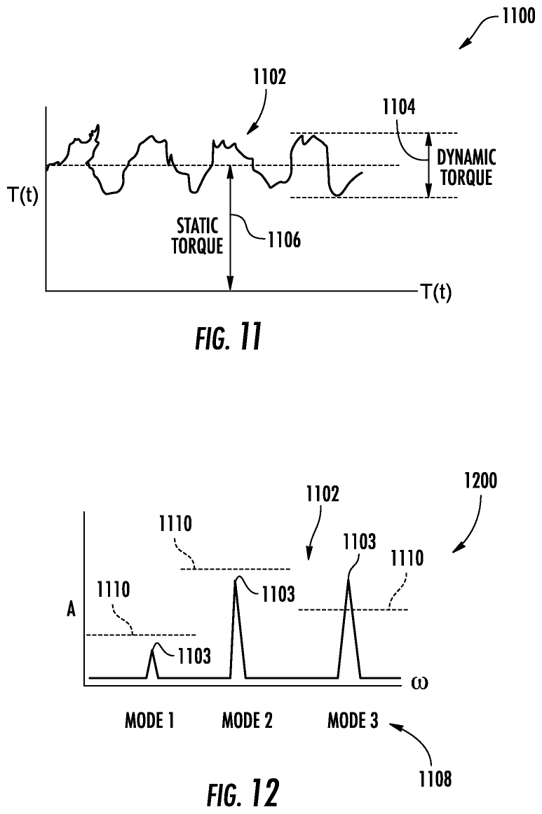

Referring briefly to FIGS. 11 and 12, FIG. 11 illustrates a graph 1100 of torque data 1102 plotted against real time (t), and FIG. 12 illustrates an FFT graph 1200 of a magnitude 1103 the torque data 1102 at various frequencies (ω) corresponding with one or more torsional operating modes 1108 (e.g., mode 1, mode 2, and mode 3) of the rotating components 204 in the drivetrain 202. The one or more torsional operating modes 1108 may be associated with a fan system (e.g., mode 1), a gearbox system (e.g., mode 2), and/or a low pressure turbine system (e.g., mode 3), which may each have a separate torque thresholds 1110. The one or more torsional operating modes 1108 of the rotating components 204 in the drivetrain 202 may be identified by the controller 106 based on the torque data 1102. As shown in FIG. 11, the torque data 1102 may include both a dynamic torque 1104 and a static torque 1106. The dynamic torque 1104 may be the range of torque data 1102 received by the controller 106 over a time period, and the static torque 1106 may be an average of the dynamic torque 1104 over the time period. That is, the dynamic torque 1104 may be time varying, and the static torque may be the mean value of the dynamic torque 1104 over a time period. As shown in FIG. 12, in many embodiments, at least partially based on the torque data 1102, the controller 106 may determine the one or more torsional operating modes 1108 of the power transmission gearbox system 200. The one or more torsional operating modes 1108 may correspond with a natural frequency of the one or more rotating components 204 in the drivetrain 202. Additionally, as shown in FIG. 12, the controller may generate a torque threshold 1110 for each of the one or more torsional operating modes 1108 at least partially based on a digital twin model (or physics based model of the gas turbine engine 10).

The engine digital twin model may virtually represent the state of the propulsion system. The engine digital twin model may include parameters and dimensions of its physical twin's parameters and dimensions that provide measured values and keeps the values of those parameters and dimensions current by receiving and updating values via outputs from sensors embedded in the physical twin. The digital twin may have respective virtual components that correspond to essentially all physical and operational components of the propulsion system.

The engine digital twin model may be stored within the memory 116 of the controller 106 and may be executable by the processor 114. In general, the engine digital twin model may be provided with one or more inputs, and at least partially based on the one or more inputs, the engine digital twin model may generate one or more outputs. For example, the engine digital twin model may receive one or more of the torque data 1102, the dynamic torque 1104, the static torque 1106, and/or the magnitude 1103 of the torque data 1102 at each torsional operating mode 1108 as an input. At least partially based on the inputs received, the controller 106 may utilize the engine digital twin model to generate the torque threshold 1110 for each of the one or more torsional operating modes 1108.

Referring back to FIG. 10, the signal processing step 304 may include extracting (via the controller 106) both the static torque 1106 and the dynamic torque 1104 for a given time period. Additionally, the signal processing step 304 may further include performing an FFT on the dynamic torque data 1102 to identify torque magnitudes 1103 for each torsional operating mode 1108. As shown in FIG. 10, the control logic diagram 300 may further include a thrust control step 306. For example, the static torque 1106 may be utilized by the controller 106 to calculate engine thrust, which may subsequently be used for feedback control of the gas turbine engine 10. For example, the static torque 1106 may be used along with a speed of the fan to determine fan power, which can be used to determine engine thrust.

Additionally, the control logic diagram 300 may include a diagnostics step 308. For example, as discussed above, the diagnostics step 308 may include determining (via the controller 106) one or more torsional operating modes 1108 of the power transmission gearbox system 200 based at least partially on the dynamic torque 1104. The one or more torsional operating modes 1108 may correspond with a natural frequency of the one or more rotating components 204. Additionally, the diagnostics step 308 may include generating a torque threshold 1110 for each of the one or more torsional operating modes 1108 at least partially based on the digital twin model (or physics based model of the gas turbine engine 10).

In many embodiments, the control logic diagram 300 may further include a prognosis step 310. The prognosis step 310 may include a step 312 of identifying torque overload conditions. A torque overload condition may include when the rotating components 204 are experiencing torque that is greater than any of the torque thresholds 1110 for a given torsional operating mode 1108. Further, a torque overload condition may include bird strikes or other engine ingestions, such that the controller 106 may determine such conditions based on the dynamic torque 1104. For example, the controller 106 may detect an overload condition in the turbomachine by determining when the dynamic torque 1104 exceeds a predetermined overload threshold, such as a predetermined overload threshold associated with engine ingestions (e.g., bird strikes).

Additionally, the prognosis step 310 may include a step 314 of updating the digital twin model if the torque overload condition is met. For example, if the controller 106 determines that the rotating components 204 are experiencing torque having a magnitude 1103 greater than the torque threshold 1110, then the controller 106 may update the digital twin model to reduce the fatigue cycle life of the rotating component 204. Additionally, the prognosis step 310 may include a step 316 of estimating the remaining useful life (e.g., hardware life) of any rotating components having undergone torque overload conditions.

In response to the prognosis step 310, the control logic diagram 300 may further include a maintenance and/or operation decision step 318. The step 318 may include adjusting one or more operating conditions of the turbomachine based on the identified overload condition. For example, if the controller 106 determines that an engine ingestion has occurred, or that the one or more rotating components 204 has been operating above the torque threshold 1110 for a period of time that exceeds a time threshold, then the controller 106 may adjust an operating condition of the turbomachine. Adjusting an operating condition may include adjusting (increasing or decreasing) fuel flow to the combustion section, adjusting a fan speed, adjusting the variable stators, adjusting the variable inlet guide vanes, actuating one or more valves, or other adjustments to mitigate the overload condition. In some embodiments, the step 318 may include initiating an engine shutdown in response to detecting the overload condition in the turbomachine, e.g., for maintenance on the gas turbine engine 10.

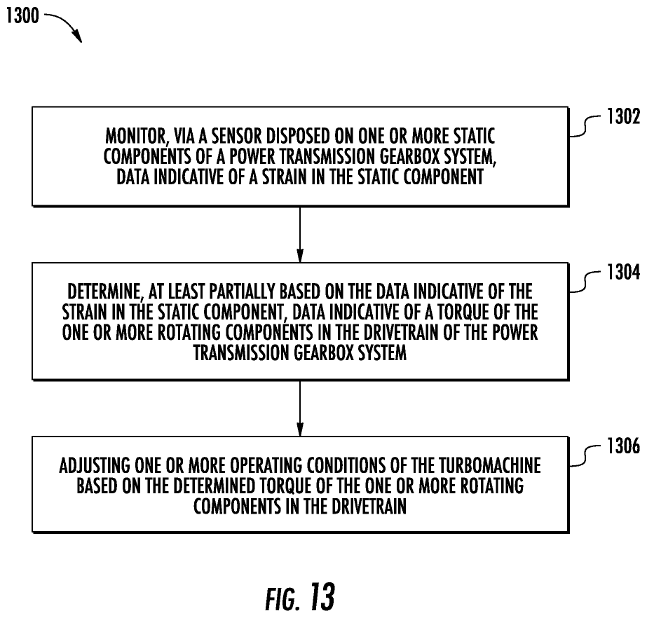

Referring now to FIG. 13, a flow diagram of one embodiment of a method 1300 for measuring torque in a power transmission gearbox system 200 for a turbomachine is illustrated in accordance with aspects of the present subject matter. In general, the method 1300 will be described herein with reference to the gas turbine engine 10 and the power transmission gearbox system 200 described above with reference to FIGS. 1 through 12. However, it will be appreciated by those of ordinary skill in the art that the disclosed method 1300 may generally be utilized with any suitable gas turbine engine and/or may be utilized in connection with a system having any other suitable system configuration. In addition, although FIG. 13 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure.

As shown in FIG. 13, the method 1300 may include, at (1302), monitoring, via a sensor 240 disposed on the one or more static components 206 of the power transmission gearbox system 200, data indicative of a strain in the static component 206. For example, the sensor may be a strain gauge, surface acoustic wave (SAW) sensor, or other suitable sensor configured to measure strain in a component. Additionally, the method 1300 may include, at (1304), determining, at least partially based on the data indicative of the strain in the static component 206, data indicative of a torque of the one or more rotating components 204 in the drivetrain 202 of the power transmission gearbox system 200. For example, the sensor 240 may be calibrated such that each measured strain value in the static component 206 corresponds with a torque value in the rotating component 204. Alternatively, or additionally, the data indicative of a strain in the static component 206 may be an input to a lookup table or set of equations stored within the controller 106, and the controller 106 may be configured to output the data indicative of a torque in the rotating component 204. For example, the torque in the fan and the low pressure turbine may be calculated using algebraic equations once the torque in the static component 206 is calculated based on the data indicative of a strain in the static component 206 (see equation below). In this way, the correlation of torque between the static component 206 (e.g., the carrier support 216 or flex mount) and rotating component 204 does not have to be calibrated with one another. However, the strain vs torque for only the static component 206 may have to go through a calibration procedure.

Particularly, the torque in the low-pressure turbine may be calculated using the following equation:

$${LPT}_{T} = \frac{CT}{1 + GR}$$

LPT_{T} is the low-pressure turbine torque. CT is the torque in the static component 206 (i.e., the carrier torque), which may be determined based on the data indicative of the strain in the static component 206. For example, the sensor 240 may measure data indicative of a strain in the static component 206, and the sensor 240 may be calibrated to output the torque in the static component 206 (i.e., the CT value). The GR is the gear ratio of the gearbox 46 (which is generally between about 6 and about 10, or such as between about 7 and about 9, or such as between about 7.5 and about 8.5, etc.).

In exemplary embodiments, the method 1300 may further include, at (1306), adjusting one or more operating conditions of the turbomachine based on the determined torque of the one or more rotating components 204 in the drivetrain 202. For example, adjusting one or more operating conditions at (1306) may include adjusting (increasing or decreasing) fuel flow to the combustion section, adjusting a fan speed, adjusting the variable stators, adjusting the variable inlet guide vanes, actuating one or more valves, or other adjustments based on the determined torque of the one or more rotating components 204. For example, if the determined torque is below a predetermined operating threshold, then the controller 106 may increase the fan speed. By contrast, if the determined torque is above a predetermined operating threshold, then the controller 106 may decrease the fan speed.

In an additional embodiment, the method 1300 may further include performing signal processing on the data indicative of the torque to generate a dynamic torque 1104 and a static torque 1106. The static torque 1106 may be an average of the dynamic torque 1104 over a period of time. In other words, the static torque 1106 may be the mean value of the dynamic torque 1104 over a time period, and the dynamic torque may be time varying. In this way, the dynamic torque 1104 may change with time and may experience peaks in magnitude, which can indicate to the controller 106 that adjustments to an operating condition of the turbomachine are necessary or warranted.

In many implementations, the method 1300 may further include determining (e.g., with the controller), at least partially based on the static torque 1106, data indicative of engine thrust of the turbomachine. For example, the controller may utilize the static torque 1106 along with fan speed to determine engine thrust. Additionally, the method 1300 may include adjusting one or more operating conditions of the turbomachine based on the determined engine thrust. adjusting one or more operating conditions may include adjusting (increasing or decreasing) fuel flow to the combustion section, adjusting a fan speed, adjusting the variable stators, adjusting the variable inlet guide vanes, actuating one or more valves, or other adjustments based on the determined engine thrust. For example, if the determined engine thrust is lower than a desired engine thrust value, then the controller may adjust one or more operating conditions of the turbomachine to increase the engine thrust to the desired engine thrust value. By contrast, if the determined engine thrust is higher than a desired engine thrust value, then the controller may adjust one or more operating conditions of the turbomachine to decrease the engine thrust to the desired engine thrust value. For example, if the determined engine thrust is about 30% higher (or such as about 20% higher, or such as about 10% higher, or such as about 5% higher, etc.) than the desired thrust value, then the controller may adjust one or more operating conditions of the turbomachine to decrease the engine thrust to the desired thrust value.

In many embodiments, the method 1300 may further include determining (e.g., with the controller) one or more torsional operating modes 1108 of the power transmission gearbox system 200. The one or more torsional operating modes 1108 may correspond with a natural frequency of the one or more rotating components 204. For example, the controller may determine, at least partially based on the dynamic torque 1104, the one or more torsional operating modes 1108 of the rotating component 204. Subsequently, the method 1300 may include generating a torque threshold 1110 for each of the one or more torsional operating modes 1108 at least partially based on a digital twin model and/or other physics-based model. The engine digital twin model may virtually represent the state of the propulsion system. The engine digital twin model may include parameters and dimensions of its physical twin's parameters and dimensions that provide measured values and keeps the values of those parameters and dimensions current by receiving and updating values via outputs from sensors embedded in the physical twin. The digital twin may have respective virtual components that correspond to essentially all physical and operational components of the propulsion system. The engine digital twin model may be stored within the memory 116 of the controller 106 and may be executable by the processor 114. In general, the engine digital twin model may be provided with one or more inputs, and at least partially based on the one or more inputs, the engine digital twin model may generate one or more outputs. For example, the engine digital twin model may receive one or more of the torque data 1102, the dynamic torque 1104, the static torque 1106, and/or the magnitude 1103 of the torque data 1102 at each torsional operating mode 1108 as an input. At least partially based on the inputs received, the controller 106 may utilize the engine digital twin model to generate the torque threshold 1110 for each of the one or more torsional operating modes 1108.

The engine digital twin model may virtually represent the state of the propulsion system. The engine digital twin model may include parameters and dimensions of its physical twin's parameters and dimensions that provide measured values and keeps the values of those parameters and dimensions current by receiving and updating values via outputs from sensors embedded in the physical twin (i.e., the gas turbine engine). The digital twin may have respective virtual components that correspond to essentially all physical and operational components of the propulsion system.

The torque threshold 1110 for each of the torsional operating modes of the rotating components 204 in the drivetrain 202 may be determined at least partially based on fatigue cycle life. For example, if the rotating components 204 in the drivetrain 202 are exposed to torque that exceeds the torque threshold 1110, then the rotating components 204 cycle life (or useful hardware life) may be reduced due to the excessive forces applied. As such, the method 1300 may further include determining when the dynamic torque 1104 of the one or more rotating components 204 exceeds the torque threshold 1110 of the one or more torsional operating modes 1108. In some implementations, the method 1300 may include determining an amount of time that the dynamic torque 1104 of a rotating component 204 exceeds the torque threshold 1110, and the controller 106 may debit or reduce the useful hardware life of the rotating component 204 based on the amount of time (e.g., more time spent in excess of threshold 1110, the greater debit to cycle life for the rotating component 204). In some implementations, the controller 106 may determine when the dynamic torque 1104 of a rotating component 204 exceeds the torque threshold 1110 for an overload time period (such as 10 seconds, or such as 30 seconds, or such as 1 minute, or such as 5 minutes, or such as 10 minutes). In exemplary embodiments, the method 1300 may further include estimating remaining hardware life of the one or more rotating components (e.g., based on the amount of time the rotating components 204 dynamic torque 1104 spends in excess of the torque threshold 1110). The method 1300 may further include adjusting one or more operating conditions of the turbomachine based on the estimated remaining hardware life of the one or more rotating components 204 in the drivetrain 202. For example, based on the estimated remaining hardware life of the rotating components 204, the controller 106 may operate the gas turbine engine in a restricted (or protective) mode, in which the drivetrain 202 is exposed to reduced torque in order to spare or increase hardware life of the one or more rotating components 204.

In additional embodiments, the method 1300 may include detecting an overload condition in the turbomachine by determining when the dynamic torque 1104 in the one or more rotating components 204 of the drivetrain 202 exceeds a predetermined overload threshold. An overload condition may include bird strikes, other engine ingestions, etc. For example, the controller 106 may detect an overload condition in the turbomachine by determining when the dynamic torque 1104 exceeds a predetermined overload threshold, such as a predetermined overload threshold associated with engine ingestions (e.g., bird strikes). In various embodiments, adjusting the one or more operating conditions at 1306 may further include initiating an engine shutdown in response to detecting the overload condition in the turbomachine. For example, if an engine ingestion or bird strike is detected, then the controller 106 may initiate shut down procedures and/or the gas turbine engine 10 may be scheduled for maintenance.

In many embodiments, the sensor 240 may be a plurality of sensors circumferentially spaced apart from one another on the at least one static component 206 (as shown in FIGS. 6 and 7). In such embodiments, the method 1300 may further include comparing the data indicative of the strain from two or more sensors in the plurality of sensors 240. Based on the compared data from the two or more sensors in the plurality of sensors 240, the method 1300 may further include determining whether the static component 206 is experiencing engine torque 242 and/or engine bending 244. For example, comparing the data indicative of the strain from each of the strain sensors may include determining the difference (e.g., the delta) in the data indicative of the strain from each of the strain sensors. If the comparison shows that the data indicative of the strain from each of the strains sensors is substantially equal (e.g., within 10% of each other, or within 5% of each other, etc.), then the controller 106 may determine that the carrier support 216 is experiencing primarily engine torque 242 (e.g., a moment force about the axial centerline of the gas turbine engine 10). Alternatively, or additionally, if the comparison shows that the data indicative of the strain from each of the strain sensors is substantially unequal (or different, such that the values are not within 10% of each other), then the controller 106 may determine that the carrier support 216 is experiencing primarily engine bending 244 (e.g., a moment force about a radial projection from the axial centerline of the gas turbine engine 10). In other words, when the difference in the data indicative of the strain from each of the sensors exceeds a threshold delta, then the controller 106 may determine that the carrier support 216 (and/or the entire gas turbine engine) is experiencing engine bending 244 as opposed to engine torque 242. The threshold delta (e.g., the difference between the data indicative of a strain of any two strain sensors in the plurality of strain sensors) may between 1% and 15%, or such as between 1% and 10%, or such as between 5% and 10%, etc. When the controller 106 determines that the threshold delta has been exceeded (i.e., that the difference between the data indicative of a strain of any two strain sensors in the plurality of strain sensors is greater than the threshold delta), then the controller 106 may determine that the carrier support 216 (and/or the entire gas turbine engine) is experiencing engine bending 244. In response, the controller 106 may adjust one or more operating conditions of the gas turbine engine 10 or may alter a flight path of the aircraft.

The system and method described above advantageously facilitate the measurement of drivetrain torque by utilizing a non-rotating strain measuring device/sensor on a static component of a power transmission gearbox system. The implementation of this sensor will enable a controller to determine static torque and also dynamic torque through the gearbox drivetrain. Once the static torque and the dynamic torque are determined by the controller, such parameters may be used to determine a low pressure turbine torque and/or a fan torque. The static torque and the dynamic torque may also be used to assess gearbox health (e.g., provide an estimate of remaining hardware life), provide a backup torque measurement, and/or to provide an additional feedback parameter for engine thrust control.

Further aspects are provided by the subject matter of the following clauses:

A power transmission gearbox system for a turbomachine, the power transmission gearbox system comprising: a drivetrain comprising one or more rotating components; at least one static component interfacing with the one or more rotating components; a sensor disposed on the at least one static component and configured to provide data indicative of strain in the static component; and a controller communicatively coupled to the sensor, the controller comprising a processor and a memory, the processor configured to perform a plurality of operations including: monitoring the data indicative of strain in the static component from the sensor; and determining, at least partially based on the data indicative of the strain in the static component, a torque in the one or more rotating components of the drivetrain.

The power transmission gearbox system as in one or more of these clauses, wherein the sensor is a plurality of sensors circumferentially spaced apart from one another on the at least one static component.

The power transmission gearbox as in one or more of these clauses, wherein the sensor is one of a strain gauge, a surface acoustic wave (SAW) sensor, or a foil gauge.

The power transmission gearbox system as in one or more of these clauses, further comprising a carrier, a pin extending through the carrier, and a carrier support surrounding the carrier and extending from the carrier, wherein the static component comprises one of the carrier, the carrier support, or the pin.

The power transmission gearbox system as in one or more of these clauses, wherein the carrier support extends from an engine frame to the carrier.

The power transmission gearbox as in one or more of these clauses, wherein one or more gears surround the pin, and wherein the carrier support surrounds the one or more gears.

The power transmission gearbox as in one or more of these clauses, wherein the sensor is disposed on the carrier support.

The power transmission gearbox as in one or more of these clauses, wherein the carrier support further comprises a conical section, and wherein the sensor is disposed on the conical section of the carrier support.

A method for measuring torque in a power transmission gearbox system for a turbomachine, the power transmission gearbox system comprising one or more rotating components in a drivetrain and one or more static components, the method comprising: monitoring, via a sensor disposed on the one or more static components of the power transmission gearbox system, data indicative of a strain in the static component; and determining, at least partially based on the data indicative of the strain in the static component, data indicative of a torque of the one or more rotating components in the drivetrain of the power transmission gearbox system; and adjusting one or more operating conditions of the turbomachine based on the determined torque of the one or more rotating components in the drivetrain.

The method as in one or more of these clauses, further comprising performing signal processing on the data indicative of the torque to generate a dynamic torque and a static torque, the static torque being an average of the dynamic torque over a period of time.

The method as in one or more of these clauses, further comprising determining, at least partially based on the static torque, data indicative of engine thrust of the turbomachine.

The method as in one or more of these clauses, further comprising adjusting one or more operating conditions of the turbomachine based on the determined engine thrust.

The method as in one or more of these clauses, further comprising: determining one or more torsional operating modes of the power transmission gearbox system, the one or more torsional operating modes corresponding with a natural frequency of the one or more rotating components; and generating a torque threshold for each of the one or more torsional operating modes at least partially based on a digital twin model.

The method as in one or more of these clauses, further comprising: determining when the dynamic torque of the one or more rotating components exceeds the torque threshold of the one or more torsional operating modes; and estimating remaining hardware life of the one or more rotating components.

The method as in one or more of these clauses, further comprising adjusting one or more operating conditions of the turbomachine based on the estimated remaining hardware life of the one or more rotating components in the drivetrain.

The method as in one or more of these clauses, further comprising detecting an overload condition in the turbomachine by determining when the dynamic torque in the one or more rotating components exceeds a predetermined overload threshold.

The method as in one or more of these clauses, wherein adjusting one or more operating conditions of the turbomachine based on the determined torque further comprises: initiating an engine shutdown in response to detecting the overload condition in the turbomachine.

The method as in one or more of these clauses, wherein the sensor is a plurality of sensors circumferentially spaced apart from one another on the one or more static components, and wherein the method further comprises: comparing the data indicative of the strain from two or more sensors in the plurality of sensors; and determining, based on the compared data from the two or more sensor in the plurality of sensors, whether the static component is experiencing engine torque or engine bending.

A controller communicatively coupled to a sensor for measuring torque in a power transmission gearbox system for a turbomachine, the power transmission gearbox system comprising one or more rotating components in a drivetrain and one or more static components, the controller comprising a processor and a memory, the processor configured to perform a plurality of operations including: monitoring, via a sensor disposed on the one or more static components of the power transmission gearbox system, data indicative of a strain in the static component; and determining, at least partially based on the data indicative of the strain in the static component, data indicative of a torque of the one or more rotating components in the drivetrain of the power transmission gearbox system; and adjusting one or more operating conditions of the turbomachine based on the determined torque of the one or more rotating components in the drivetrain.

The controller as in one or more of these clauses, further comprising performing signal processing on the data indicative of the torque to generate a dynamic torque and a static torque, the static torque being an average of the dynamic torque over a period of time.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A power transmission gearbox system for a turbomachine, the power transmission gearbox system comprising:
a drivetrain comprising one or more rotating components;
at least one static component interfacing with the one or more rotating components;
a sensor disposed on the at least one static component and configured to provide data indicative of strain in the static component; and
a controller communicatively coupled to the sensor, the controller comprising a processor and a memory, the processor configured to perform a plurality of operations including:
monitoring the data indicative of strain in the static component from the sensor; and
determining, at least partially based on the data indicative of the strain in the static component, a torque in the one or more rotating components of the drivetrain.

2. The power transmission gearbox system as in claim 1, wherein the sensor is a plurality of sensors circumferentially spaced apart from one another on the at least one static component.

3. The power transmission gearbox as in claim 1, wherein the sensor is one of a strain gauge, a surface acoustic wave (SAW) sensor, or a foil gauge.

4. The power transmission gearbox system as in claim 1, further comprising a carrier, a pin extending through the carrier, and a carrier support surrounding the carrier and extending from the carrier, wherein the static component comprises one of the carrier, the carrier support, or the pin.

5. The power transmission gearbox system as in claim 4, wherein the carrier support extends from an engine frame to the carrier.

6. The power transmission gearbox as in claim 4, wherein one or more gears surround the pin, and wherein the carrier support surrounds the one or more gears.

7. The power transmission gearbox as in claim 4, wherein the sensor is disposed on the carrier support.

8. The power transmission gearbox as in claim 4, wherein the carrier support further comprises a conical section, and wherein the sensor is disposed on the conical section of the carrier support.

9. A method for measuring torque in a power transmission gearbox system for a turbomachine, the power transmission gearbox system comprising one or more rotating components in a drivetrain and one or more static components, the method comprising:
monitoring, via a sensor disposed on the one or more static components of the power transmission gearbox system, data indicative of a strain in the static component; and
determining, at least partially based on the data indicative of the strain in the static component, data indicative of a torque of the one or more rotating components in the drivetrain of the power transmission gearbox system; and
adjusting one or more operating conditions of the turbomachine based on the determined torque of the one or more rotating components in the drivetrain.

10. The method as in claim 9, further comprising performing signal processing on the data indicative of the torque to generate a dynamic torque and a static torque, the static torque being an average of the dynamic torque over a period of time.

11. The method as in claim 10, further comprising determining, at least partially based on the static torque, data indicative of engine thrust of the turbomachine.

12. The method as in claim 11, further comprising adjusting one or more operating conditions of the turbomachine based on the determined engine thrust.

13. The method as in claim 10, further comprising:
determining one or more torsional operating modes of the power transmission gearbox system, the one or more torsional operating modes corresponding with a natural frequency of the one or more rotating components; and
generating a torque threshold for each of the one or more torsional operating modes at least partially based on a digital twin model.

14. The method as in claim 13, further comprising:
determining when the dynamic torque of the one or more rotating components exceeds the torque threshold of the one or more torsional operating modes; and
estimating remaining hardware life of the one or more rotating components.

15. The method as in claim 14, further comprising adjusting one or more operating conditions of the turbomachine based on the estimated remaining hardware life of the one or more rotating components in the drivetrain.

16. The method as in claim 10, further comprising detecting an overload condition in the turbomachine by determining when the dynamic torque in the one or more rotating components exceeds a predetermined overload threshold.

17. The method as in claim 16, wherein adjusting one or more operating conditions of the turbomachine based on the determined torque further comprises:
initiating an engine shutdown in response to detecting the overload condition in the turbomachine.

18. The method as in claim 9, wherein the sensor is a plurality of sensors circumferentially spaced apart from one another on the one or more static components, and wherein the method further comprises:
comparing the data indicative of the strain from two or more sensors in the plurality of sensors; and
determining, based on the compared data from the two or more sensor in the plurality of sensors, whether the static component is experiencing engine torque or engine bending.

19. A controller communicatively coupled to a sensor for measuring torque in a power transmission gearbox system for a turbomachine, the power transmission gearbox system comprising one or more rotating components in a drivetrain and one or more static components, the controller comprising a processor and a memory, the processor configured to perform a plurality of operations including:
monitoring, via a sensor disposed on the one or more static components of the power transmission gearbox system, data indicative of a strain in the static component;
determining, at least partially based on the data indicative of the strain in the static component, data indicative of a torque of the one or more rotating components in the drivetrain of the power transmission gearbox system; and
adjusting one or more operating conditions of the turbomachine based on the determined torque of the one or more rotating components in the drivetrain.

20. The controller as in claim 19, further comprising performing signal processing on the data indicative of the torque to generate a dynamic torque and a static torque, the static torque being an average of the dynamic torque over a period of time.
